(19) United States
(12) Patent Application Publication
(10) Pub. No.: US 2005/0258082 A1
(43) Pub. Date: Nov. 24, 2005

(54) Additive dispensing system and water filtration system

(76) Inventors: Mark Thomas Lund, West Chester, OH (US); Matthew Keith Florian Williquette, Cincinnati, OH (US); David James Emmons, Plymouth, MN (US); John David Tanner, Plymouth, MN (US)

Correspondence Address: The Procter & Gamble Company;IP Division Central Docketing,, WHBC - FC Box 161, 6110 Center Hill Avenue, Cincinnati, OH, 45224, US

(21) Appl. No.: 10/852,708

(22) Filed: May 24, 2004

(51) Int. Cl. B01D 35/157

(52) U.S. Cl. 210/101; 210/94; 210/449; 210/435; 210/210

(57) ABSTRACT

A water filtration system having a water inlet connectable to an unfiltered water source, a water filter in fluid communication with the water inlet, an outlet in communication with the water filter operable to dispense filtered water and an additive dispensing system having a reservoir for containing an additive and additive outlet. The additive dispensing system is operable to selectively dispense an amount of additive to water filtered by the filter.

### FIELD OF THE INVENTION

The present invention relates generally to filtered water and water filtration systems with the ability to add a consumable additive, and more specifically to a unique system for dispensing a consumable additive to filtered water.

### BACKGROUND OF THE INVENTION

Water treatment devices for home and other uses are well known in the art. Such devices are typically incorporated in a water system either in-line or at a terminal end. An example of the former would be an under-the-counter device which filters water prior to reaching a faucet outlet. There are two common types of terminal end devices—countertop and faucet mounted. Water treatment devices can treat water by the use of mechanical filtration or chemical treatment. Most water-filtration systems use a filter-cartridge containing either activated carbon or a combination of activated carbon and an ion-exchange resin. The activated carbon serves to filter out particulates and other impurities, while eliminating most of the chlorine present in the water. The ion-exchange resin removes positive ions such as calcium, thereby softening the water. A negative side-effect of the above-mentioned systems is that various other healthy minerals can be removed by the ion-exchange resin. An alternative method of water purification is reverse osmosis, but products using this technology are not widely utilized by household consumers due to their high costs.

In recent years, consumption of water by people has risen due to better health education and other information available to the public. However, public perception of the poor quality and taste of regular tap water has led to the development and sale of a number of products addressing these problems. Various bottled waters are available to consumers. Some of these bottled waters have additional additives which the consumer may find beneficial. Such additives include nutrients, vitamins, minerals and flavorings. These bottled waters are sometimes called fitness waters, vitamin waters or enhanced waters. However, the cost and inconvenience of obtaining enhanced bottled water products on a regular basis may discourage consumers from consuming additional water. Accordingly, a more convenient and cost effective approach for providing enhanced water to the public is needed.

### SUMMARY OF THE INVENTION

The present invention is directed to water filtration systems and, more particularly, to water filtration systems which enable a user to selectively dispense an amount of an additive to filtered water. Another embodiment of the present invention is an additive dispensing system for a water filtration system which may be added to an existing water filtration system.

One embodiment of the present invention is a water filtration system. The water filtration system comprises a water inlet connectable to an unfiltered water source; a water filter in fluid communication with the water inlet; an outlet in communication with the water filter operable to dispense filtered water; and an additive dispensing system comprising a reservoir for containing an additive and an additive outlet, wherein the additive dispensing outlet is operable to selectively dispense an amount of additive to the water filtered by the filter.

Another embodiment of the present invention is an additive dispensing system for a water filtration system. The additive dispensing system comprises a reservoir for containing an additive and an additive outlet, wherein the additive dispensing system is operable to selectively dispense an amount of additive to filtered water; and a housing operable to attach the reservoir and additive outlet to the water filtration system.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a schematic illustration of an exemplary water filtration system according to an embodiment of the present invention;

FIG. 2 is a schematic illustration of an exemplary water filtration system according to an embodiment of the present invention;

FIG. 3 is a schematic illustration of an exemplary water filtration system according to an embodiment of the present invention;

FIG. 4 is a schematic illustration of an exemplary water filtration system according to an embodiment of the present invention;

FIG. 5 is a schematic illustration of an exemplary water filtration system according to an embodiment of the present invention;

FIG. 6 is a schematic illustration of an exemplary water filtration system according to an embodiment of the present invention;

FIG. 7 is a schematic illustration of an exemplary water filtration system according to an embodiment of the present invention;

FIG. 8 is a schematic illustration of an exemplary additive dispensing system according to an embodiment of the present invention;

FIG. 9 is a schematic illustration of an exemplary additive dispensing system according to an embodiment of the present invention;

FIG. 10 is a schematic illustration of an exemplary water filtration system according to an embodiment of the present invention;

FIG. 11 is a schematic illustration of an exemplary additive dispensing system on a refrigerator according to an embodiment of the present invention; and

FIG. 12 is a schematic illustration of an exemplary water filtration system according to an embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

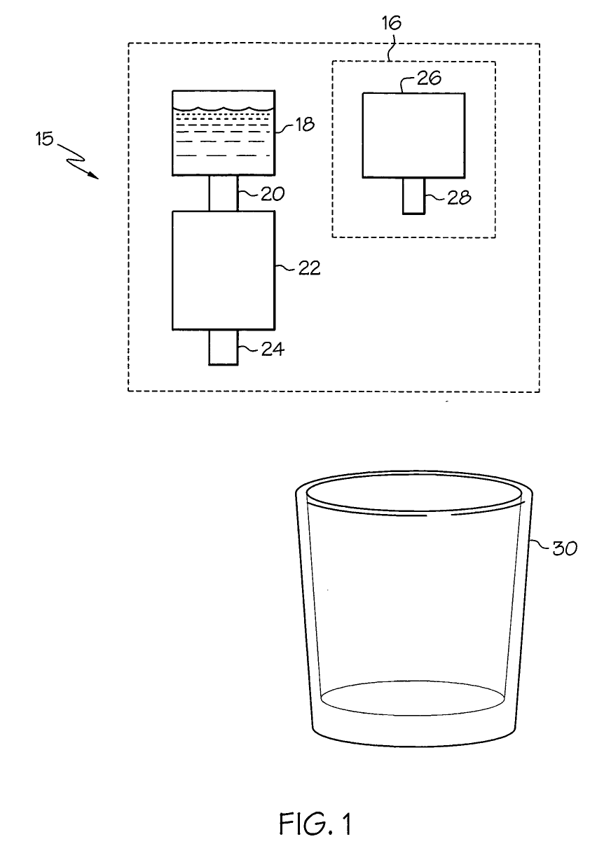

FIG. 1 illustrates an exemplary water filtration system 15 according to one embodiment of the present invention. The water filtration system 15 comprises a water inlet 20 connectable to an unfiltered water source 18. The water inlet 20 is in fluid communication with the water filter 22. The water filter 22 is operable to filter one or more contaminants or particulates from the unfiltered water. An outlet 24 is in communication with the water filter 22 and is operable to dispense filtered water. The water filtration system 15 further comprises an additive dispensing system 16. The additive dispensing system 16 comprises a reservoir 26 for containing an additive and an additive outlet 28. The additive dispensing system 16 is operable to selectively dispense an amount of additive to the filtered water. In one exemplary embodiment, filtered water dispensed from the outlet 24 is dispensed into a glass or other container 30 and an additive is dispensed into the filtered water in the container 30 through the additive outlet 28.

The water inlet 20 is connectable to any unfiltered water source. Exemplary unfiltered water sources comprise garden hose, water line, water faucet mounts, water reservoirs, water pitchers and dispensers and the like.

The water filter 22 may comprise any water filter technology known to one skilled in the art. Such water filter media may include, activated carbon or the like for removal of organics from the water; halogenated resin fibers and/or halogenated resin beads or other media, for destroying bacteria and viruses within the water; ion exchange resins (such as halogen based action exchange resin for the removal of sodium) for removal of ionic materials from the water; and removing bacteria by microfiltration. One exemplary water filter that may be employed in the present invention is disclosed by Hou et al., U.S. Pat. No. 6,565,749.

In one embodiment, the additive in the reservoir 26 is in a liquid form. In another embodiment, the additive in the reservoir 26 is in the form of a dry powder. The additive comprises one or more additives selected from the group consisting of flavorings, vitamins, minerals and nutrients. Additive minerals include minerals selected from the group consisting of ions calcium, silicate, chloride, magnesium, potassium, sodium, selenium, zinc, iron, manganese and mixtures thereof. Vitamin additives comprise vitamins selected from the group consisting of vitamin B12, vitamin C and mixtures thereof. In other embodiments, homeopathic remedies and herbal remedies, as well as flavorings, may be included as additive in the reservoir 22.

In one embodiment, the additive comprises hydroalcoholic extracts of natural oils. Other additives may comprise elixirs, spirits or essences and tinctures. An elixir is a clear, sweetened hydroalcoholic liquid intended for oral use. The alcohol content ranges from about 5% to about 50% by volume. Spirits or essences are alcoholic or hydroalcoholic solutions prepared from vegetable or chemical substances. The concentration of the solute varies up to 50%. The hydroalcoholic extracts of natural oils range from about 0.025 to about 0.5% by volume of the filtered water to deliver a hint of flavor to the filtered water. In another embodiment, the additives may comprise one or more coloring agents, such as food coloring, to add a color to the filter water. Exemplary flavors comprise lemon, lime, berry, citrus, orange, strawberry and mixtures of the same.

The reservoir 26 may be constructed from any material known to one skilled in the art that would not contaminate or have its material properties effected by the additive. Exemplary materials of construction for the reservoir 26 include polymers, for example, polypropylene (PP), polyethylene terephthalate (PET), high density polyethylene (HDPE), low density polyethylene (LDPE), polyvinyl chloride (PVC), polystyrene, nylon, polyester, and the like. Other exemplary materials of construction include aluminum foil. In one embodiment, the reservoir 26 comprises multiple layers of the material. In another embodiment, any flexible material with suitable barrier properties may be utilized.

While the schematic illustration in FIG. 1 depicts the outlet 24 and additive outlet 28 separately dispensing water and additive, respectively, to the container 30, it is equally within the illustrated systems and invention that the additive outlet 28 may be in fluid communication with the outlet 24. For example, the water filtration system may further comprise an outlet mixer configured to combine the outlet 24 and the additive outlet 28 into one outlet stream, prior to dispensing the resulting mixture to the container 30.

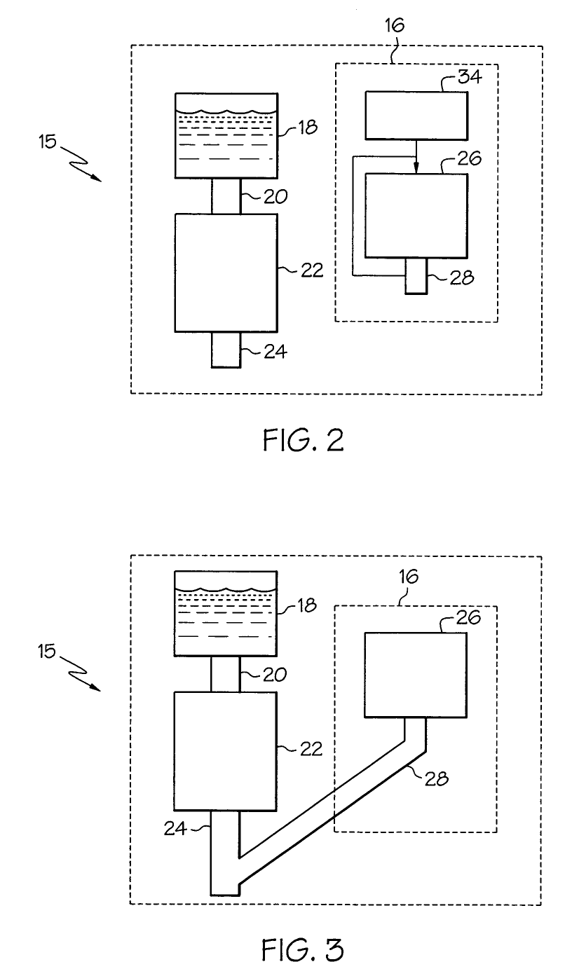

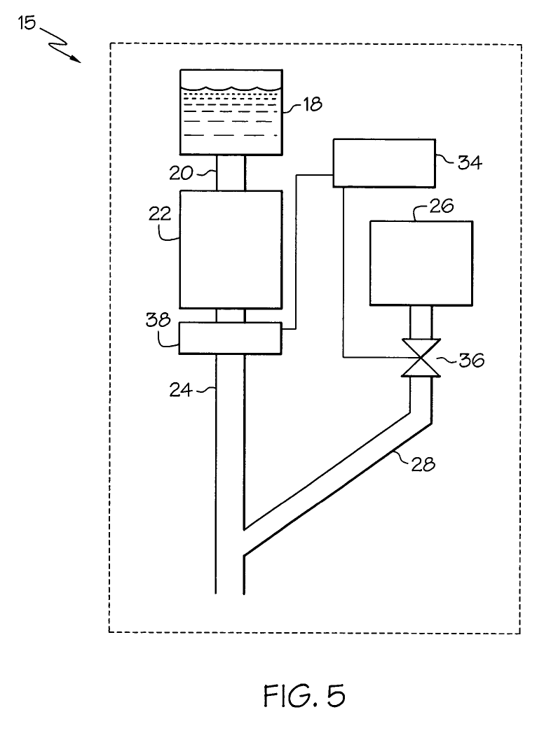

In one exemplary embodiment as illustrated in FIG. 2, the water filtration system 15 further comprises a controller 34 in communication with the additive outlet 28. The controller 34 is configured to regulate the amount of additive dispensed through the additive outlet 28. The controller 34 may comprise a limiting valve 36 (see FIG. 5). The limiting valve 36 is operable to limit or regulate the amount of additive, if any, that is dispersed through the additive outlet 28. In another embodiment, the controller 34 may comprise a microprocessor in communication with a limiting valve 36. In one exemplary embodiment, the controller 34 may comprise a dial or other input device to allow the user to select the amount of additive to be dispensed into the filtered water.

In yet another exemplary embodiment, illustrated in FIG. 3, the water filtration system 15 comprises a water inlet 20 in communication with the unfiltered water source 18, such as a faucet. A water filter 22 is in communication with the water inlet 20 and filtered water from the water filter 22 is dispensed at the outlet 24. The additive dispensing system 16 comprises a reservoir 26 for containing an additive and an additive outlet 28. In this embodiment, the additive outlet 28 is in fluid communication with the outlet 24. In one exemplary embodiment, as illustrated in FIG. 10, the additive outlet 28 and the outlet 24 connect together inside a housing 40 of the water filtration system 15 at an outlet mixer 42, such that the exterior of the water filtration system 15 only has one outlet stream.

In one embodiment of the present invention, the additive outlet 28 and outlet 24 are configured and placed in communication in such a way as to create a venturi suction effect when filtered water in the outlet 24 moves past the additive outlet 28. This venturi suction effect generates a vacuum that pulls the additive in the additive outlet 28 into the filtered water flowing through the outlet 24.

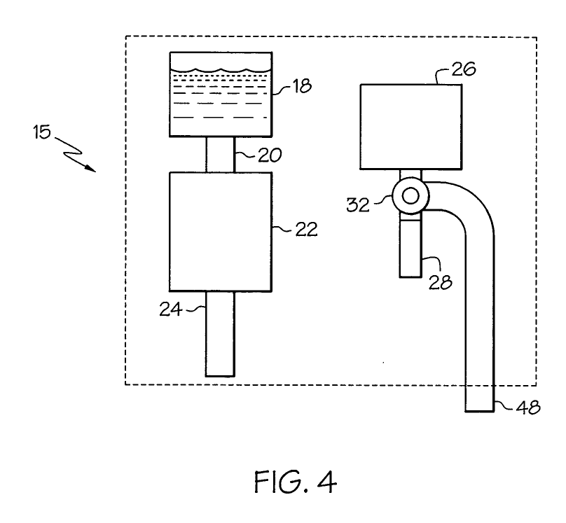

In another exemplary embodiment of the present invention, illustrated in FIG. 4, the additive dispensing system 16 further comprises a pump 32. The pump 32 is in communication with the reservoir 26 and the additive outlet 28. The pump 32 is configured to transport additive from the reservoir 26 to the additive outlet 28 to be added to filtered water. In one embodiment, the pump 32 comprises a diaphragm pump. As one skilled in the art will appreciate any pump known to one skilled in the art may be utilized to transfer the additive to the additive outlet 28. Exemplary pumps include piston pumps, peristaltic pumps, and bellows-type pumps. In another exemplary embodiment, the additive dispensing system further comprises a manual activator, for example a push bar 48, in communication with the pump 32. The push bar 48 is configured to activate the pump 32 when pressure is applied to the push bar 48. The push bar 48, allows a user to manually selectively dispense an amount of additive to the filtered water.

In one exemplary embodiment as illustrated in FIG. 5, the water filtration system 15 comprises a water inlet 20 in communication with an unfiltered water source 18, such as a water faucet. The water inlet 20 is in communication with the water filter 22. A mineral content analyzer 38 is in fluid communication with the outlet of the water filter 22. The mineral content analyzer 38 is operable to measure the concentration of one or more minerals in the filtered water. The water filtration system 15 further comprises a controller 34 in communication with the mineral content analyzer 38. A reservoir 26 containing one or more additives is in communication with an additive outlet 28 and a limiting valve 36. The limiting valve 36 is in communication with a controller 34, such that the controller 34 is operable to dispense one or more additives (such as minerals) to yield a predetermined concentration of additives in the filtered water. For example, the mineral content analyzer 38, detects a level of calcium in the filtered water and reports the calcium level to the controller 34. The controller 34 determines that additional calcium is desired in the final treated water product, and as such, sends a signal to the limiting valve 36 to add and/or increase the amount of additive (i.e. calcium) being dispensed through the additive outlet 28 to the filtered water. As one skilled in the art will appreciate, any controller known to one skilled in the art may be utilized to control the amount of additive dispensed into the filtered water.

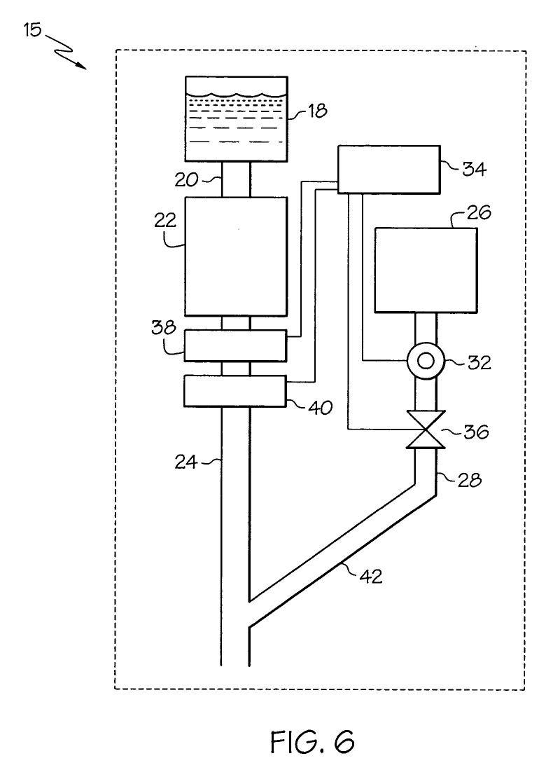

Another exemplary embodiment of the present invention is illustrated in FIG. 6. In this embodiment, the water filtration system 15 comprises a water inlet 20 connectable to an unfiltered water source 18. The water inlet 20 is in fluid communication with the water filter 22, such that unfiltered water from the unfiltered water source 18 flows through the water inlet 20 and through the water filter 22 toward the outlet 24. After the water has been filtered by the water filter 22, the water passes over a mineral content analyzer 38 and/or a flow meter 40. The mineral content analyzer 38 is operable to measure the concentration of one or more minerals in the filtered water. The flow meter 40 is operable to measure the flow rate of water exiting the water filter 22. The flow meter 40 is configured to send a signal to the controller 34, wherein the signal corresponds to a flow rate of water exiting the water filter 22. The controller 34 receives the mineral content signal for the mineral content analyzer 38 and a flow rate signal from the flow meter 40. The controller 34 then sends a signal to the pump 32 and/or the limiting valve 36 which are in communication with the reservoir 26. The signal from the controller 34 activates the pump 32 and/or limiting valve 36 to allow an amount of additive from the reservoir 26 to be dispensed through the additive outlet 28 to the filtered water. The amount of additive is a function of the signals received from the mineral content analyzer 38 and/or the flow meter 40. In an alternative embodiment, as shown in FIG. 6, an outlet mixer 42 is configured to place the additive outlet 28 in fluid communication with the outlet 24. In an alternative embodiment, the additive outlet 28 could be separate from the outlet 24 and not in fluid communication with each other. As one skilled in the art will appreciate, any sensor known to one skilled in the art may be utilized for detecting various components of the filtered water. An exemplary sensors includes a TDS (total dissolved solids) sensor from HM Digital of Los Angeles, Calif.

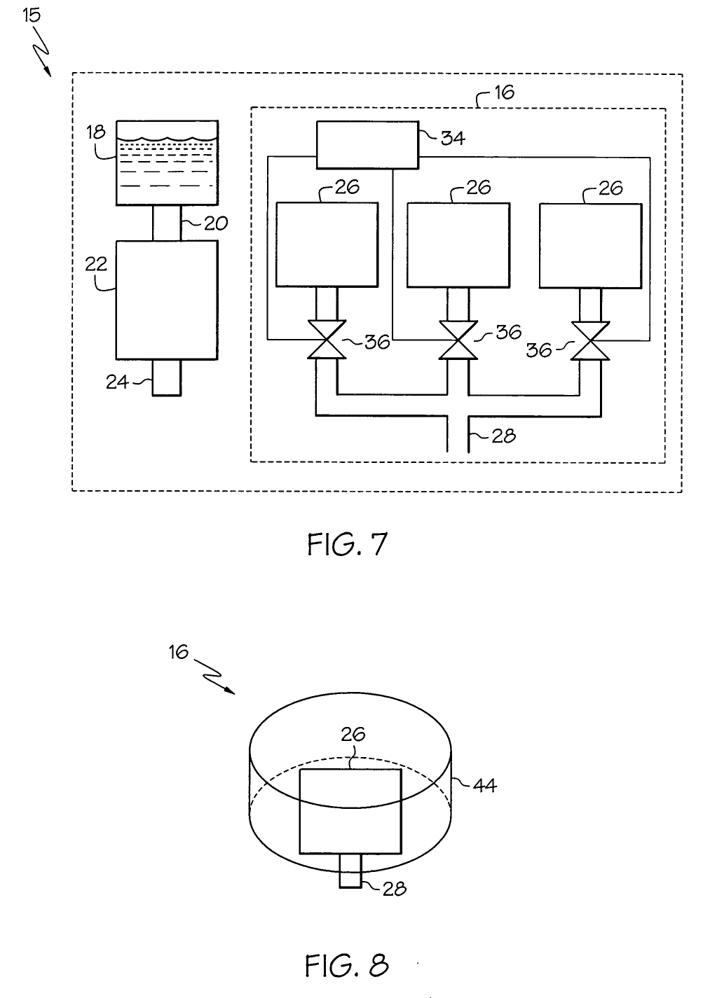

In another embodiment of the present invention, as illustrated in FIG. 7, the water filtration system 15 comprises a water inlet 20 connectable to an unfiltered water source 18, such as a faucet. The water inlet 20 is in fluid communication with the water filter 22. The water filter 22 is operable to filter the unfiltered water from the unfiltered water source 18 for one or more contaminants or pollutants. The filtered water from the water filter 22 is dispensed to the outlet 24. In this embodiment, the additive dispensing system 16 comprises a plurality of reservoirs 26. Each reservoir 26 comprises one or more additives to be selectively dispensed to the filtered water. A controller 34 is configured to allow a user to select which, if any, of the reservoirs 26 should dispense the additives to the filtered water. In one embodiment, the controller 34 sends a signal to the limiting valve 36 to regulate the flow of the additive through the additive outlet 28 to the filtered water. As discussed above, in one embodiment, the additive outlet 28 and the outlet 24 may be in fluid communication with each other or be joined with an outlet mixer 42. In an alternative embodiment, the reservoir 26 may comprise a plurality of chambers, wherein each chamber contains an additive to be dispensed to the filtered water.

Another embodiment of the present invention is illustrated in FIG. 8. In this embodiment, the additive dispensing system 16 is configured to be added to a prior existing water filter of the user. This embodiment allows a user who already has purchased a water filtration system to add the novel additive dispensing system of the present invention. In this embodiment, a housing 44 is connected to the reservoir 26 and the additive outlet 28. The housing 44 is configured to attach to or slide over the user's existing water filter to allow the additive outlet 28 to be in proximity to the outlet of the existing water filter. In one embodiment, the additive outlet 28 comprises flexible tubing to be placed near the outlet of the existing water filter. In another embodiment, the housing 44 may be configured to replace a portion of the prior existing water filter. For example, the housing 44 may be configured to screw on and replace a component of the existing water filter housing.

In one embodiment, the reservoir 26 is releasably connected to the water filtration system 15. This allows the reservoir 26 to easily be changed when the reservoir 26 is empty or the user desires a different additive contained in a separate reservoir 26 to be added to the filtered drinking water. In one embodiment, the additive dispensing system is operable to selectively dispense from about 0.01 ml of additive to about 1.0 ml of additive per 250 ml of water filtered by the filter. In a further embodiment, the additive dispensing system is operable to selectively dispense from about 0.1 ml of additive to about 0.5 ml of additive per 250 ml of water filtered by the filter. In another embodiment, the additive dispensing system is operable to selectively dispense from about 0.025 to about 0.25% additive by volume of water filtered by the filter. In a further embodiment, the additive dispensing system is operable to selectively dispense from about 0.05 to about 0.1% additive by volume of water filtered by the filter.

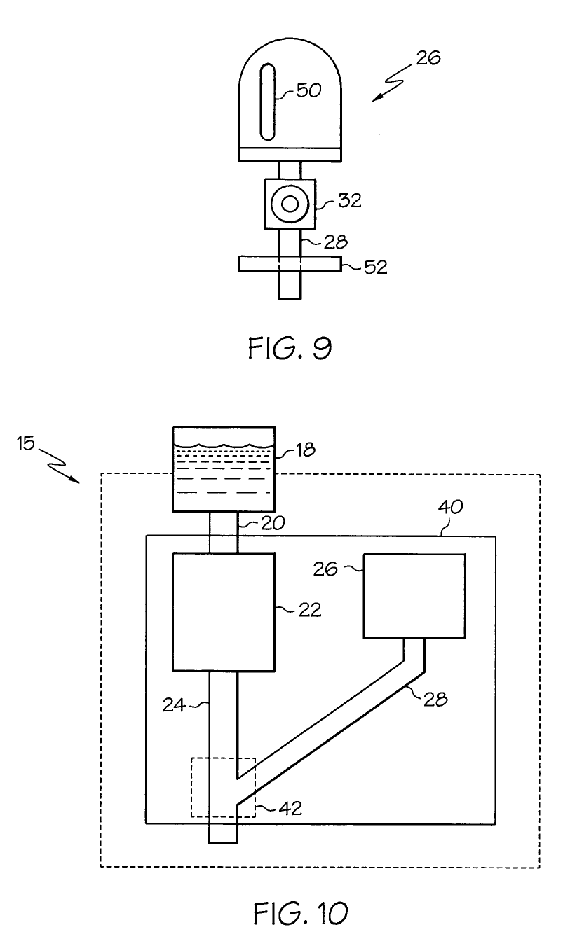

In yet another embodiment as illustrated in FIG. 9, the additive dispensing system 16 further comprises an additive life indicator 50 operable to indicate the remaining amount of additive in the reservoir 26. For example, the reservoir 26 may comprise a visible level gauge 50 to allow the user to determine the amount of additive remaining in the reservoir. In another embodiment, the additive dispensing system 16 may further comprise a totalizer 52 which is operable to calculate the amount of additive dispensed from the additive dispensing system 16, and configurable to indicate the remaining amount of additive remaining in the reservoir 26. In such an arrangement, a flow meter or totalizer is coupled to the additive life indicator and sends a signal to the additive life indicator to cause it to light up or flash after a predetermined volume of additive has flowed through the additive outlet. In an alternative embodiment, the life indicator may comprise a monitoring mechanism such as a microchip containing a programmable clock. The additive life indicator could be implemented as, for example, light emitting diodes or LCD (liquid crystal display) readouts, wherein a clock is programmed to cause the additive life indicator to, for example, light up or flash after a predetermined period of time has passed since installing a new reservoir, for example, two months. A user could then replace the reservoir with a new reservoir and reset the clock.

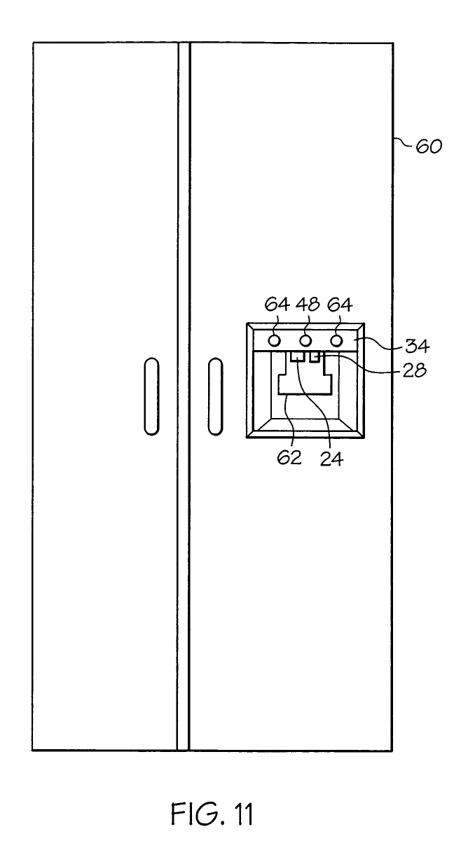

In another embodiment of the present invention as illustrated in FIG. 11, the additive dispensing system of the present invention is incorporated into a water filtration system on a refrigerator 60. In one exemplary embodiment, the controller 34 is located on a refrigerator door 60. The controller 34 may have one or more manual activators 48 to dispense an additive from the reservoir (not shown). The user may place a container 30 in contact with the water flow switch 62 to activate the flow of filtered water through the outlet 24 and into the container. In another exemplary embodiment, the controller 34 comprises one or more input selectors 64 to allow the user to select an amount and/or the type of additive, if any, to be dispensed with the filtered water.

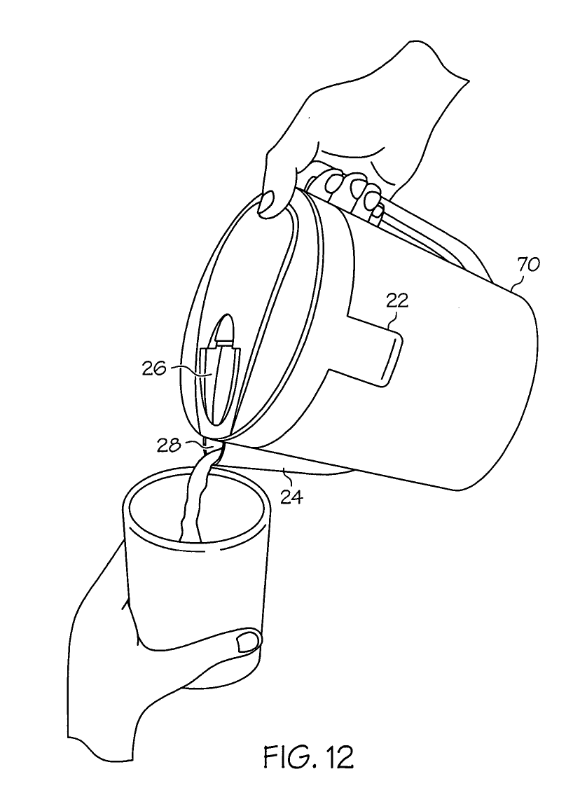

Other embodiments of the present invention are not limited to use with faucets or the like. For example, elements of the present invention could be adapted for use with portable containers such as pitchers, water bottles or with other drinking water delivery system such as water coolers or refrigerators. For example, one exemplary embodiment of the present invention, as illustrated in FIG. 12, comprises an attachment for a container 70 such as a pitcher or water bottle could be designed to include a filter 22 and a replaceable reservoir 26 containing additives. The additive outlet 28 could be placed near the outlet 24 of the container 70 to allow additives to be dispensed to the filtered water. Similarly, elements of the present invention could be installed into a water cooler or refrigerator, and operated by corresponding buttons, switches, and the like to selectively dispense an additive to filtered water.

All documents cited in the detailed description of the invention are, in relevant part, incorporated herein by reference; a citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A water filtration system, comprising:
a water inlet connectable to an unfiltered water source;
a water filter in fluid communication with the water inlet;
an outlet in communication with the water filter operable to dispense filtered water; and
an additive dispensing system comprising a reservoir for containing an additive and an additive outlet, wherein the additive dispensing system is operable to selectively dispense an amount of additive to water filtered by the filter.

2. The water filtration system of claim 1, wherein the additive comprises a liquid.

3. The water filtration system of claim 1, wherein the additive comprises one or more additives selected from the group consisting of: flavorings, vitamins, minerals and nutrients.

4. The water filtration system of claim 1, wherein the additive dispensing system further comprises a pump operative to selectively dispense an amount of additive to water filtered by the filter.

5. The water filtration system of claim 4, wherein the pump comprises a diaphragm pump.

6. The water filtration system of claim 4, wherein the additive dispensing system further comprises a manual activator in communication with the pump, wherein the manual activator is configured to activate the pump when pressure is applied to the manual activator.

7. The water filtration system of claim 1, further comprising a filter housing, wherein the filter housing contains the water filter and the additive dispensing system.

8. The water filtration system of claim 1, further comprising a filter housing, wherein the additive dispensing system is located outside of the filter housing.

9. The water filtration system of claim 1, wherein the additive dispensing system further comprises a controller configured to regulate the amount of additive dispensed through the additive outlet.

10. The water filtration system of claim 9, wherein the controller comprises a microprocessor.

11. The water filtration system of claim 9, wherein the additive dispensing system further comprises a limiting valve.

12. The water filtration system of claim 9, further comprising a mineral content analyzer in communication with the controller, wherein the mineral content analyzer is operable to measure the concentration of one or more minerals in water filtered by the filter, and wherein the controller is operable to dispense one or more minerals to yield a predetermined concentration of minerals in water filtered by the filter.

13. The water filtration system of claim 9, further comprising a flow meter in communication with the controller, and wherein the flow meter is configured to send a signal to the controller, wherein the signal corresponds to a flow rate of water through the water filter, and wherein the controller is operable to read the signal and determine whether to alter the amount of additive being dispensed to the water filtered by the filter.

14. The water filtration system of claim 1, wherein the outlet and the additive outlet are in fluid communication.

15. The water filtration system of claim 1, wherein the additive dispensing system is operable to selectively dispense from about 0.01 ml to about 1.0 ml of additive per 250 ml of water filtered by the filter.

16. The water filtration system of claim 1, further comprising an additive life indicator operable to indicate a remaining amount of additive in the reservoir.

17. The water filtration system of claim 1, wherein the reservoir is releasably connected to the water filtration system.

18. The water filtration system of claim 1, wherein the additive dispensing system comprises a plurality of reservoirs, each reservoir containing a respective additive.

19. The water filtration system of claim 1, wherein the reservoir comprises a plurality of chambers and wherein each of the plurality of chambers contains an additive.

20. The water filtration system of claim 1, wherein the water inlet is connectable to a water faucet.

21. An additive dispensing system for a water filtration system, comprising:
a reservoir for containing an additive and an additive outlet, wherein the additive dispensing system is operable to selectively dispense an amount of additive to filtered water; and
a housing operable to attach the reservoir and additive outlet to a water filtration system.
